(19) United States
(12) Patent Application Publication
(10) Pub. No.: US 2014/0001739 A1
(43) Pub. Date: Jan. 2, 2014

(54) OUTRIGGER WITH REPLACEABLE FOOT MOUNT

(71) Applicant: John RUTHERFORD, Huntington, WV (US)

(72) Inventor: John RUTHERFORD, Huntington, WV (US)

(21) Appl. No.: 13/918,305

(22) Filed: Jun. 14, 2013

Related U.S. Application Data
(60) Provisional application No. 61/666,254, filed on Jun. 29, 2012.

(51) Int. Cl. B60S 9/12

(52) U.S. Cl. CPC B60S 9/12
USPC 280/766.1

(57) ABSTRACT

Exemplary embodiments of an outrigger having a replaceable foot mount may be described. The replaceable foot mount may be removably coupled to a hydraulic cylinder using a variety of fasteners. The replaceable foot mount can be easily removed and replaced when broken to allow outriggers to be quickly repaired and deployed to new work locations.

### CROSS REFERENCE TO RELATED APPLICATIONS

This application claims priority from U.S. Provisional Patent Application No. 61/666,254, filed Jun. 29, 2012, the entire contents of which are hereby incorporated by reference.

### BACKGROUND

In construction, manufacturing, drilling, and other situations where heavy objects are used, support outriggers are often used to provide strength and stability to the object. In particular, support outriggers are often used where stability is critical or where the object itself is heavy or is used to lift heavy objects. Support and stability is particularly important in mining or drilling, where the heavy object is supported on potentially unstable ground that is subject to environmental changes, for example, rain or mud causing the soil underneath an outrigger to become soft. In these operating environments, it is not uncommon for outriggers to sink into the ground due to the weight supported by the outriggers.

Commonly, outriggers are single units that can extend outwards from the object supported by each outrigger using a linear actuator like a hydraulic cylinder, and a base plate or supporting pad is attached to the end of a piston rod or similar that can be retracted or extended. When an outrigger sinks into the ground, workers typically have to pull the outrigger from the ground in order to move the object being supported by the outrigger. The resulting stress on the outrigger often causes the outrigger to break near the coupling point where the hydraulic cylinder is attached to a foot pad. Because outriggers are often single units, replacement requires a great deal of time to disconnect the broken outrigger, cut away the broken swiveling foot mount, weld a new swiveling foot mount onto the outrigger, and reconnect the repaired outrigger. Because objects supported by outriggers cannot typically be used without the stability provided by the attached outriggers, the time spent repairing a broken outrigger delays the movement of heavy equipment to new work sites

### BRIEF DESCRIPTION

An outrigger having a replaceable foot mount may be disclosed. Exemplary embodiments of the outrigger may have a hydraulic cylinder, a first pivoting joint configured to couple the outrigger to an object being supported by the outrigger, a second pivoting joint, a hydraulic cylinder coupled to the first pivoting joint at a first end and removably coupled to the second pivoting joint at a second end, and a removable foot pad. Exemplary embodiments of the coupling between the second pivoting joint and second end of the hydraulic cylinder may include rod-type fasteners, latch-type fasteners, bayonet coupling, sexless coupling, or a combination of multiple fasteners.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 shows an exemplary embodiment of an outrigger having a replaceable foot mount.

FIG. 2 shows an exemplary embodiment of a coupling between a replaceable foot mount and a hydraulic cylinder using a plurality of cylindrical fasteners.

FIG. 3 shows an exemplary embodiment of a coupling between a replaceable foot mount and a hydraulic cylinder using a plurality of latch-type fasteners.

FIG. 4 shows an exemplary embodiment of a coupling between a replaceable foot mount and a hydraulic cylinder using a bayonet-type mount.

FIG. 4a shows an embodiment of a base of a replaceable foot mount having a plurality of lugs.

FIG. 4b shows an embodiment of an end of a hydraulic cylinder having slots configured to accept each of the plurality of lugs and channels configured to securably hold each of the plurality of lugs.

FIG. 5 shows an exemplary embodiment of a coupling between a second end of a hydraulic cylinder and a mounting plate coupled to said second end.

FIG. 5a shows an embodiment of a coupling between a second end of a hydraulic cylinder and a mounting plate having a plurality of bores in the mounting plate, a bore in the second end of the hydraulic cylinder, and a retaining pin configured to be inserted through the bores in the mounting plate and second end of the hydraulic cylinder.

FIG. 5b shows an embodiment having a retaining pin longer than the width of the mounting plate with a pin hole at an end of the retaining pin and a second retaining pin inserted through the pin hole.

FIG. 5c shows an embodiment having a threaded retaining pin and a threaded second fastener coupled to the end of the retaining pin.

### DETAILED DESCRIPTION OF THE INVENTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

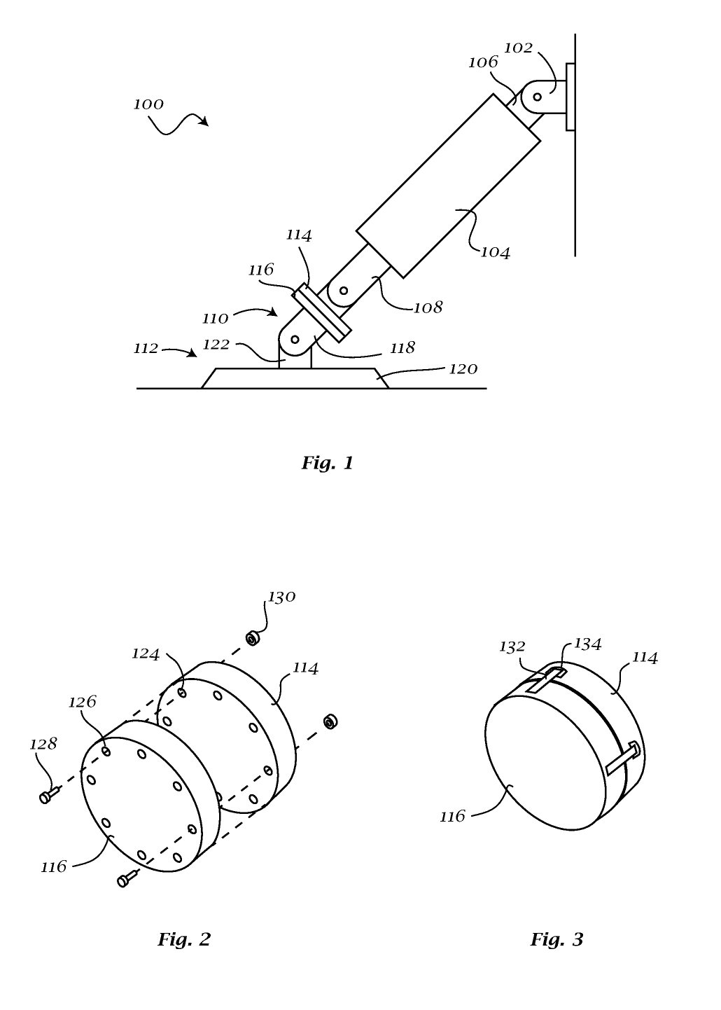

Referring generally to FIGS. 1-4, exemplary embodiments of an outrigger having a replaceable foot mount may be disclosed. Outrigger 100 may have a first pivoting joint 102, a hydraulic cylinder 104 having a first end 106 and a second end 108, a second pivoting joint 110, and a foot 112. A mounting plate 114 may be coupled to the second end 108. First pivoting joint 102 may be coupled to any object requiring support from one or more outriggers 100. In some embodiments, this coupling may be removable; in other embodiments, this coupling may be fixed. The first end 106 of hydraulic cylinder 104 may be rotatably coupled to first pivoting joint 102. Second pivoting joint 110 may be removably coupled mounting plate 114. Foot 112 may be pivotally coupled to second pivoting joint 110.

Second pivoting joint 110 may have a base 116 and at least one coupling member 118. Foot 112 may have a foot pad 120 and a coupling member 122. Coupling member 122 of foot 112 may be pivotally coupled to the at least one coupling member 118 of second pivoting joint 110. In some exemplary embodiments, coupling member 122 of foot 112 may be pivotally coupled to coupling member 118 of second pivoting joint 110 using a rod-and-pin combination. In other exemplary embodiments, the coupling member 122 of foot 112 may be pivotally coupled to at least one coupling member 118 of second pivoting joint 110 using a threaded rod and a plurality of nuts on both ends of the threaded rod, a rod and bushings, or any other appropriate coupling mechanism as known in the art. In some embodiments, the coupling between second pivoting joint 110 and foot 112 may be configured to have a single degree of freedom; in other embodiments, the coupling between second pivoting joint 110 and foot 112 may allow for up to three degrees of rotational freedom to allow foot 112 to have maximum contact with the ground.

Referring now to FIG. 2, second pivoting joint 110 may be removably coupled to the mounting plate 114 coupled to the second end 108 of hydraulic cylinder 104 using a plurality of rod-type fasteners. Mounting plate 114 may be substantially the same size and shape as base 116 of second pivoting joint 110. Mounting plate 114 may have a plurality of fastener holes 124, and base 116 may have a corresponding number of fastener holes 126. Fasteners 128 may couple the second pivoting joint 110 to hydraulic cylinder 104. In some embodiments, fastener holes 124 and 126 and fastener 128 may be threaded. In an embodiment where fastener holes 124 or 126 are threaded, fasteners 128 may be configured to have a length substantially similar to the combined height of fastener holes 124 and 126 such that the second pivoting joint 110 and hydraulic cylinder 104 are coupled by the friction of threading on a fastener 128 and the threading in fastener holes 124 and 126. Where a more secure fit is desired, fasteners 128 may be longer than the combined height of fastener holes 124 and 126, and a second fastener 130 may be coupled to the end of fastener 128. Fasteners 128 may be bolts, pins, or other appropriate fasteners as known in the art, and second fasteners 130 may be nuts, pins, or other appropriate fasteners capable of coupling to fasteners 128 as known in the art.

In other embodiments, fastener holes 124 and 126 may have a smooth bore. In some embodiments, fastener 128 may be longer than the combined height of fastener holes 124 and 126 such that the second pivoting joint 110 and mounting plate 114 may be coupled between the head of fastener 128 and a second fastener 130. In some embodiments, fastener 128 may have threading on the end of the fastener, and second fastener 130 may have a corresponding thread to allow second fastener 130 to couple to the threaded portion of fastener 128. In other embodiments, fastener 128 and second fastener 130 may be pins configured such that second fastener 130 can be positioned substantially perpendicular to fastener 128, or other appropriate fasteners as known in the art.

Referring now to FIG. 3, a further exemplary embodiment of an outrigger having a replaceable foot mount may be disclosed. Second pivoting joint 110 may have a plurality of fasteners 132 disposed around the perimeter of base 116, and mounting plate 114 may have a corresponding number of second fasteners 134 disposed around the perimeter of mounting plate 114. Fasteners 132 and 134 may be a latch, spring latch, or any other appropriate fastener as known in the art. Fasteners 132 and 134 may be recessed into the perimeter of base 116 of second pivoting joint 110 and mounting plate 114 so as not to protrude from the perimeter of base 116 or mounting plate 114.

In some embodiments, second pivoting joint 110 may be coupled to the mounting plate 114 coupled to the second end 108 of hydraulic cylinder 104 using a combination of fasteners. Base 116 of second pivoting joint 110 may be substantially the same size as mounting plate 114. Mounting plate 114 may have a plurality of fastener holes 124 and a plurality of fasteners 134 disposed around the perimeter of second end 108, and base 116 of second pivoting joint 110 may have a plurality of fastener holes 126 and a plurality of fasteners 132 disposed around the base 116. Second pivoting joint 110 may be coupled to the second end 108 of hydraulic cylinder 104 by (1) inserting a fastener 128 through each of the plurality of fastener holes 124 and 126 and optionally coupling a second fastener 130 to fastener 128 and (2) coupling each of the plurality of fasteners 132 to a corresponding fastener 134.

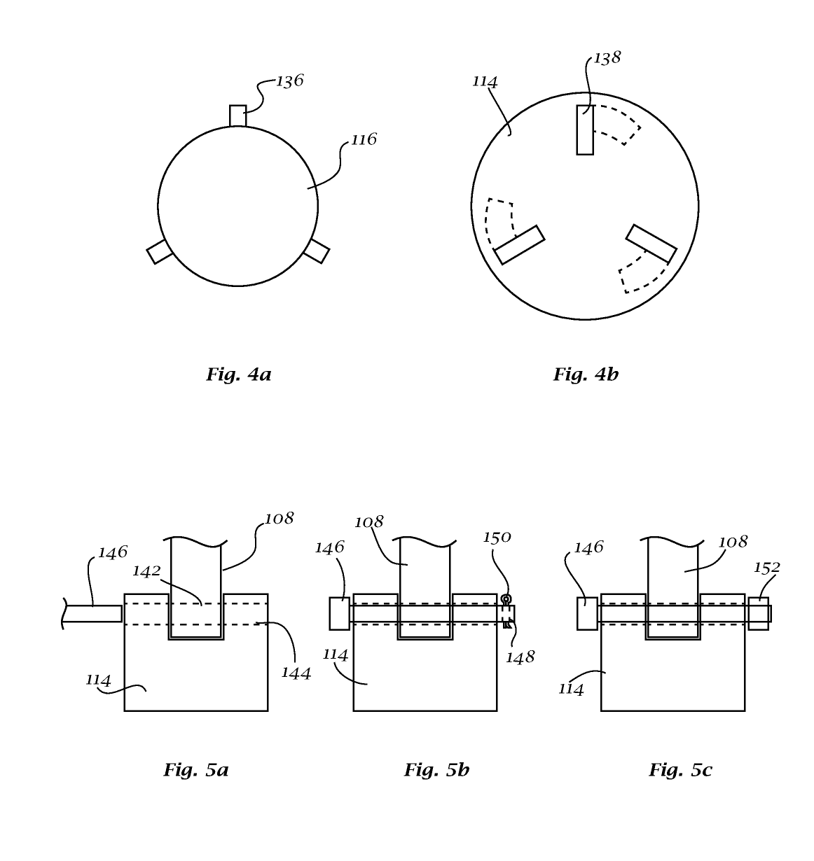

Now generally referring to FIG. 4, a still further exemplary embodiment of an outrigger having a replaceable foot mount may be disclosed. Base 116 of second pivoting joint 110 may form a bayonet coupling with mounting plate 114. Specifically referring to FIG. 4a, an exemplary embodiment of base 116 of second pivoting joint 110 may be disclosed. Base 116 of second pivoting joint 110 may have a plurality of lugs 136 protruding from the body of base 116. Specifically referring to FIG. 4b, an exemplary embodiment of mounting plate 114 may be disclosed. Mounting plate 114 may have a number of flanges 138 corresponding to the number of lugs 136 coupled to base 116 of second pivoting joint 110. Each lug 136 may engage with a corresponding flange 138 to couple second pivoting joint 110 to mounting plate 114. In another exemplary embodiment, lugs 136 and flanges 138 may be flattened tabs that couple together in a bayonet mounting. In still further exemplary embodiments, base 116 of second pivoting joint 110 and mounting plate 114 may be a sexless coupling, similar to a Storz-type coupling. It may be recognized, however, that any other rotatable coupling, whether threaded or nonthreaded, known in the art may be used to couple base 116 of second pivoting joint 110 and mounting plate 114 together.

Referring now generally to FIG. 5, an exemplary embodiment of the mounting plate 114 coupled to the second end 108 of hydraulic cylinder 104 may be disclosed. Mounting plate 114 may be larger than second end 108 of hydraulic cylinder 104. Mounting plate 114 may have a receptacle 140 substantially the size of second end 108. Second end 108 may have at least one bore 142, and mounting plate 114 may have at least one bore 144. Bores 142 and 144 may be substantially similar in size. At least one retaining pin 146 may couple second end 108 to mounting plate 114 through a bore 142 of second end 108 and a corresponding bore 144 of mounting plate 114. In an exemplary embodiment, mounting plate 114 may have two bores 144 disposed directly opposite each other, and send end 108 may have a single bore 142 such that a single retaining pin 146 may couple the mounting plate 114 to the second end 108 of hydraulic cylinder 104. It may be recognized, however, that any number of bores 142 and 144 and retaining pins 146 may be used

In some embodiments, retaining pin 146 may couple second end 108 of hydraulic cylinder 104 and mounting plate 114 using a friction fit. In an embodiment, the length of retaining pin 146 may be substantially similar to the width of mounting plate 114. In another exemplary embodiment, retaining pin 146 may be longer than the width of mounting plate 114. In such an embodiment, retaining pin 146 may have a first and second end and a pin hole 148 at each of the first and second ends. A second retaining pin 150 may be inserted into a pin hole 148 to further secure second end 108 of hydraulic cylinder 104 and mounting plate 114.

In a still further exemplary embodiment, retaining pin 146 may be threaded. In some embodiments, bores 142 and 144 may be smooth, and the length of retaining pin 146 may be greater than the width of mounting plate 114. A second fastener 152 may be coupled to an end of retaining pin 146 to secure second end 108 of hydraulic cylinder 104 and mounting plate 114. In another embodiment, bores 142 and 144 may also be threaded. In some embodiments, the length of retaining pin 146 may be substantially the width of mounting plate 114; in other embodiments, retaining pin 146 may be longer than the width of mounting plate 114, and a second fastener 152 may be coupled to an end of retaining pin 146.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An outrigger, comprising:
a first pivoting joint configured to be coupled to a device requiring support;
a second pivoting joint;
a hydraulic cylinder having first and second ends, the first end coupled to the first pivoting joint and the second end removably coupled to the second pivoting joint; and
a foot pad coupled to the second pivoting joint.

2. The outrigger of claim 1, wherein the hydraulic cylinder further comprises a mounting plate coupled to the second end and the second pivoting joint comprises a base plate and at least one coupling member configured to allow the coupling of the foot pad to the at least one coupling member.

3. The outrigger of claim 2, wherein the mounting plate coupled to the second end of the hydraulic cylinder and the base plate of the second pivoting joint have at least one bore configured to allow the base plate of the second pivoting joint to be coupled to the mounting plate of the second end of the hydraulic cylinder using at least one retaining pin.

4. The outrigger of claim 3, wherein at least one bore of the mounting plate coupled to the second end of the hydraulic cylinder and the base plate of the second pivoting joint and at least one retaining pin is threaded.

5. The outrigger of claim 4, wherein at least one threaded second fastener is coupled to the at least one threaded retaining pin.

6. The outrigger of claim 3, wherein at least one retaining pin further comprises a pin hole, said pin hole configured to hold a second retaining pin.

7. The outrigger of claim 2, wherein the mounting plate of the second end of the hydraulic cylinder and the base plate of the second pivoting joint have a plurality of fastener holes, and wherein a plurality of first fasteners couple together the mounting plate of the second end of the hydraulic cylinder and the base plate of the second pivoting joint.

8. The outrigger of claim 7, wherein at least one of the plurality of fastener holes and at least one of the plurality of first fasteners are threaded.

9. The outrigger of claim 7, further comprising a plurality of second fasteners each coupled to one of the plurality of first fasteners.

10. The outrigger of claim 9, wherein at least one of the second fasteners is threaded.

11. The outrigger of claim 9, wherein at least one of the first fasteners and one of the second fasteners are pins.

12. The outrigger of claim 2, wherein a plurality of first fasteners are coupled to the perimeter of the mounting plate coupled to the second end of the hydraulic cylinder and a plurality of second fasteners are coupled to the perimeter of the base plate of the second pivoting joint.

13. The outrigger of claim 2, wherein the mounting plate coupled to the second end of the hydraulic cylinder and the base plate of the second pivoting joint form a bayonet coupling.

14. The outrigger of claim 2, wherein the mounting plate coupled to the second end of the hydraulic cylinder and the base plate of the second pivoting joint are sexless couplings.

15. An outrigger, comprising:
a first pivoting joint configured to be coupled to a device requiring support;
a mounting plate having a plurality of fastener holes and a plurality of fasteners disposed around the perimeter of the mounting plate;
a hydraulic cylinder having first and second ends, the first end coupled to the first pivoting joint and the second end coupled to the mounting plate;
a second pivoting joint having a base plate and at least one coupling member, wherein the base plate has a plurality of fastener holes and a plurality of fasteners disposed around the perimeter of the base plate configured to couple to the plurality of fasteners disposed around the perimeter of the mounting plate;
a plurality of fasteners configured to couple the base plate of the second pivoting joint to the mounting plate through one of the plurality of fastener holes in the mounting plate and base plate of the second pivoting joint; and
a foot pad coupled to the at least one coupling member of the second pivoting joint.
